(19) United States
(12) Patent Application Publication
(10) Pub. No.: US 2010/0077660 A1
(43) Pub. Date: Apr. 1, 2010

(54) SUSPENDED PLANTING PLATFORM FOR A PLANT CONTAINER

(76) Inventor: Laura Messano, Massapequa, NY (US)

Correspondence Address: TUTUNJIAN + BITETTO, P.C., 20 CROSSWAYS PARK NORTH, SUITE 210, WOODBURY, NY, 11797, US

(21) Appl. No.: 12/238,706

(22) Filed: Sep. 26, 2008

(51) Int. Cl. A01G 9/02

(52) U.S. Cl. 47/65.5

(57) ABSTRACT

A planting system is provided including a plant container having a depth and a top rim defining a top opening and a planting platform configured for insertion within the top opening of the plant container. In one embodiment, the planting platform includes a base having a perimeter, a sidewall having a bottom portion connected to the perimeter of the base, the sidewall having a top portion and including a lip protruding radially outwards from the top portion thereof. The lip includes a barrier edge extending upwards from an outer perimeter of the lip.

### BACKGROUND OF THE INVENTION

1. Technical Field of the Invention

The present invention generally relates to planting receptacles and more particularly to a suspended, planting platform for insertion within a top portion of a plant container for reducing the volume of planting material which may be placed within the plant container.

2. Description of Related Art

There are millions of avid gardeners worldwide who enjoy gardening, in particular, container gardening. Often, gardeners use containers for growing many different types of flowers and plants. There exists today a wide variety of planting pots and planting containers for indoor and outdoor use, in a range of sizes adapted for placement on windowsills, on floors, etc., and for growing a wide variety of plants.

In a typical configuration, a planting pot comprises a cylindrical form having a hollow interior, although any other shape or form, e.g., rectangular, octagonal, oval, etc., may be contemplated. The hollow interior is adapted to hold a certain volume of soil, depending on the size of the container, and is typically required to be almost entirely filled with soil from bottom to top in order to correctly position a plant near the top of the container.

However, in many situations, the volume of soil that must be used for each pot is unused by the plant, and thus wasted, since the root systems of many ornamental plants and flowers typically only use the upper few inches of soil in the pot for adequate growth. “Over-potting” is a common and highly undesirable problem, as excess soil below the roots may retain large amounts of water and cause “wet feet”, causing poor drainage, poor aeration of the soil, and subsequent root rot. In addition, the user will face the problem of excessive cost in purchasing unused potted soil. Furthermore, the weight of the wasted soil makes it unduly difficult and strenuous for the gardener to lift and transport the container.

U.S. Pat. No. 6,962,022 B2 issued to Shannon, outlines a suspended a barrier for a plant pot, which will allow water from the layer of soil to seep through. The barrier is constructed of thermoplastic material.

U.S. Pat. No. U.S. Pat. No. 6,584,730 B1 issued to Mai, outlines a flowerpot that includes a shoulder adapted to be formed on an inner periphery of a second pot and a watering system provided.

U.S. Pat. No. 6,955,008 B2 issued to Rose, outlines an aerating base plate designed for placement in the bottom of a conventional plant receptacle. The plate's sidewall features a number of openings that also enable water and air to flow into, and out of, an interior area of the plate.

U.S. Pat. No. U.S. Pat. No. 7,234,272 B2 issued to Aiba, outlines raising pots for vegetable seedlings that are produced by molding a mixture including a boiled fiber material.

U.S. Pat. No. U.S. Pat. No. 7,234,273 B2 issued to Aiba, outlines molded pots for root crop seedlings that are produced by molding a mixture comprising un-boiled bamboo fiber.

U.S. Pat. No. U.S. Pat. No. 6,389,751 B1 issued to Wang, outlines an apparatus and method of cultivating a plant using a sub-irrigating method.

U.S. Pat. No. U.S. Pat. No. 6,615,539 B1 issued to Obonai, outlines a water-retaining support material for plants comprising a hydrogel-forming polymer (A) having calcium ion absorption, having a chlorine ion content and having a water absorption magnification in ion-exchange.

U.S. Pat. No. U.S. Pat. No. 6,505,440 B1 issued to Lai outlines a double-layer flowerpot is constructed to include an outer pot body, the outer pot body having an upright bottom tube, an inner pot body mounted on the outer pot body.

U.S. Pat. No. U.S. Pat. No. 6,516,562 B2 issued to Astle outlines an irrigation/fertilization filter apparatus for continuously supplying liquid to plants and trees.

However, there exists a need for a system and device for facilitating container planting in a way which minimizes soil waste and overall weight of the container while overcoming the disadvantages and limitations of the prior art.

### SUMMARY OF THE INVENTION

The present invention provides a sturdy, insertable and easily-removable planting apparatus configured for placement within a pot which reduces the volume of soil/potting material required to be used and accordingly, reduces the overall weight of a planted container. Advantageously, the present invention provides a simplified and robust suspended planting device which is easy to use and is provided in different sizes to accommodate insertion within various size plant pots and containers, whether plastic, clay, etc.

One object of the invention is to provide a planting platform for the gardener that enables easy manipulation while moving and carrying a planted container, therefore making a heavy and cumbersome plant container lightweight, manageable and easily moved, lifted and carried, even when fully planted.

It is another object of the invention to conserve on the use of soil/planting material and thus reduce economic costs for the gardener.

According to one aspect, a suspended planting tray or platform is provided designed for insertion within a plant container, the planting tray having an outer lip adapted to project beyond a perimeter of a top surface of the plant container, so as to suspend the tray at the top of the container. The suspended planting tray includes drainage holes and is adapted to hold a fraction, e.g., about ¼ to one third, of the soil that the overall plant container can hold. Advantageously, a suspended planting tray/platform according to the present invention enables less soil to be used to grow plants, thus conserving the amount of soil used and enabling the planted container to weigh considerably less.

According to another aspect of the present invention, a planting platform is provided for placement within a plant container comprising a base having a perimeter, a sidewall having a bottom portion connected to the perimeter of the base, the sidewall having a top portion and including a lip protruding radially outwards from the top portion thereof, wherein the lip includes a barrier edge extending upwards from an outer perimeter of the lip.

According to yet another aspect, a planting system is provided comprising a plant container having a depth and a top rim defining a top opening and a planting platform configured for insertion within the top opening of the plant container. The platform comprises a base having a perimeter, a sidewall having a bottom portion connected to the perimeter of the base, the sidewall having a top portion and including a lip protruding radially outwards from the top portion thereof, wherein the lip includes a barrier edge extending upwards from an outer perimeter of the lip.

According to yet another aspect, a planting platform for placement within a plant container is provided comprising a tray base having a perimeter, a sidewall having a bottom portion connected along the perimeter of the base, a bottom plate; and at least one leg having a first end connected to the tray base and a second end connected to the bottom plate.

### BRIEF DESCRIPTION OF THE DRAWINGS

FIG. 1 is an top perspective view of a resting/suspended tray inserted in a plant container according to an aspect of the present invention;

FIG. 2 is a perspective cross-sectional view of the resting/suspended tray inserted in a plant container of FIG. 1 according to an aspect of the present invention;

FIG. 3 is a side cross-sectional view of the resting/suspended tray inserted in a plant container of FIG. 1 according to an aspect of the present invention;

FIG. 4 is a side view of the resting/suspended tray for a plant container according to an aspect of the present invention;

FIG. 5 is a top view of the resting/suspended tray for a plant container according to an aspect of the present invention;

FIG. 6 is a top perspective view of a leg-supported tray according to another embodiment of the present invention; and

FIG. 7 is a side cross-sectional view of the leg-supported tray of FIG. 6 inserted in a plant container according to an aspect of the present invention.

It should be understood that the drawings are for purposes of illustrating the concepts of the invention and are not necessarily the only possible configurations for illustrating the invention.

### DETAILED DESCRIPTION OF THE PREFERRED EMBODIMENTS

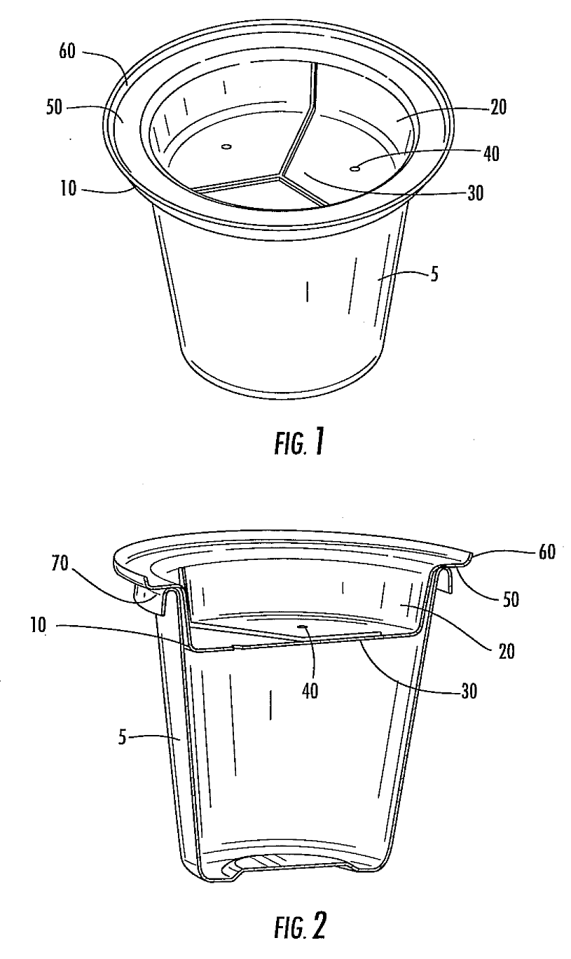

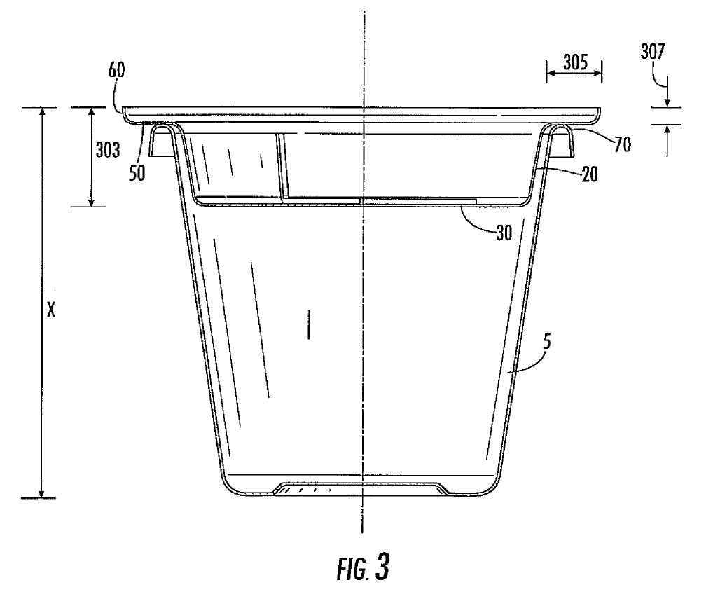

For explanatory purposes, the embodiments discussed below are described with respect to, e.g., a cylindrical planting container of the type having a circular top opening. However, it is to be noted that application of the present principles to any type, shape, composition or size of planting container, flower pot, window box, etc., whether for indoor or outdoor use, may be contemplated. The description of a suspended planting tray according to the present invention with respect to a cylindrical planting container as shown in FIGS. 1-5 is by way of example and not limitation.

Referring now to the Figures, FIGS. 1-3 are exemplary views of a suspended planting platform inserted within a plant container according to one embodiment of the present invention.

In this exemplary embodiment, a container 5 is provided comprising an elongate cylindrical pot having a hollow interior, a top rim 70 defining a top opening, and a depth X. It is noted that alternate container shapes, e.g., rectangular, octagonal, square, triangular, oval, etc. may be contemplated, and the size/shape of the container 5 is in no way limited to the embodiment depicted in the FIGS.

A suspended planting platform 10 is provided, configured to nest on top of the container 5, and thus here comprises a circular member having a base 30 connected to sidewalls 20 which extend upwards therefrom. The base 30 may be flat, slanted, curved, shaped, multi-sided, semi-circular, etc., and preferably includes one or more holes or apertures 40 for drainage and airflow.

The sidewalls 20 are preferably shaped and sized to fit within a perimeter of the rim 70 of a corresponding container 5, e.g., in a nesting configuration. For example, for containers 5 having graduated or slanted sides, a platform 10 having correspondingly graduated sidewalls 20 may be provided.

A lip 50 is provided protruding horizontally and radially outwards from the top of the sidewalls 20 so as to rest on top of the rim 70 of the container 5. Preferably, the lip 50 is configured to protrude outwards for a width 305 of at least about 3.0 inches from the sidewalls 20, although alternate dimensions may be contemplated. The lip 50 advantageously allows the platform 10 to rest securely within the container 5.

The lip 50 may further include a barrier edge 60 protruding upwards along the outermost perimeter of the lip 50. The barrier edge 60 enables soil to be applied all the way to the edge of the lip 50 and helps keep the soil contained within the platform 10, thus facilitating a natural look which conceals the tray while at the same time preventing spillage. Preferably, the barrier edge 60 is configured to be at least 14 inch high (height 307).

The suspended planting platform 10 may be comprised of any material, e.g., clay, plastic, stone, composites, etc., and be used both indoors and outdoors. In use, a platform 10 is placed atop the upper part of a container 5, the platform 10 having a smaller circumference/perimeter than the container 5 so as to be readily insertable therein. The platform 10 may be accordingly filled with soil or any other desired planting medium and planted with desired plants. In one embodiment, the platform has a depth 303 in the range of at least about 3-5 inches deep, which is adequate for the root systems of many decorative types of flowers and plants. Drainage of water is facilitated via the holes 40.

In cases where the container 5 has an alternate shape, e.g., a square shape, the platform 10 may be correspondingly shaped (e.g., square-shaped) and configured to nest within the top of the shaped container 5.

In one exemplary embodiment, the depth 303 of the planting platform 10 is preferably at least about ¼ to about ⅓ of the depth X of the container 5 within which it will be used. This advantageously allows the gardener to save soil in the amount of the remaining ⅔ to three-quarters of the volume of the container 5. This not only saves on the cost of potting material and soil, but reduces the amount of exertion spent by the gardener in lifting planted containers.

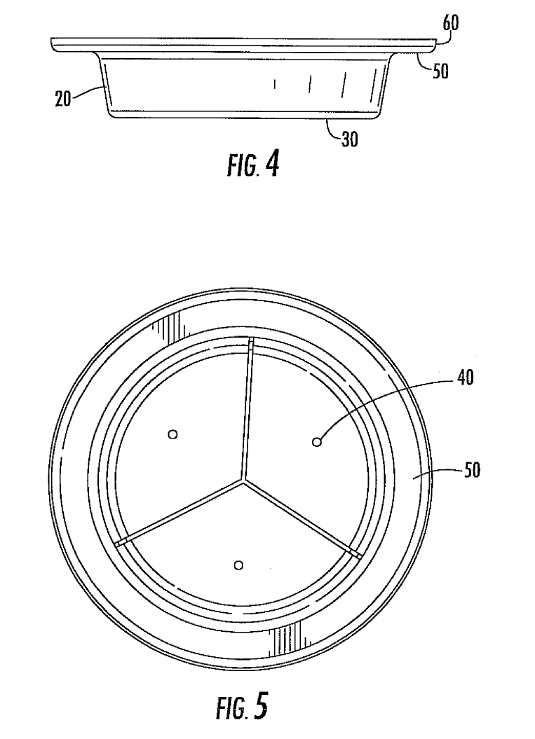

FIGS. 4-5 depict exemplary side and top views, respectively, of a planting platform 10 configured for insertion into a cylindrical container according to an aspect of the present invention.

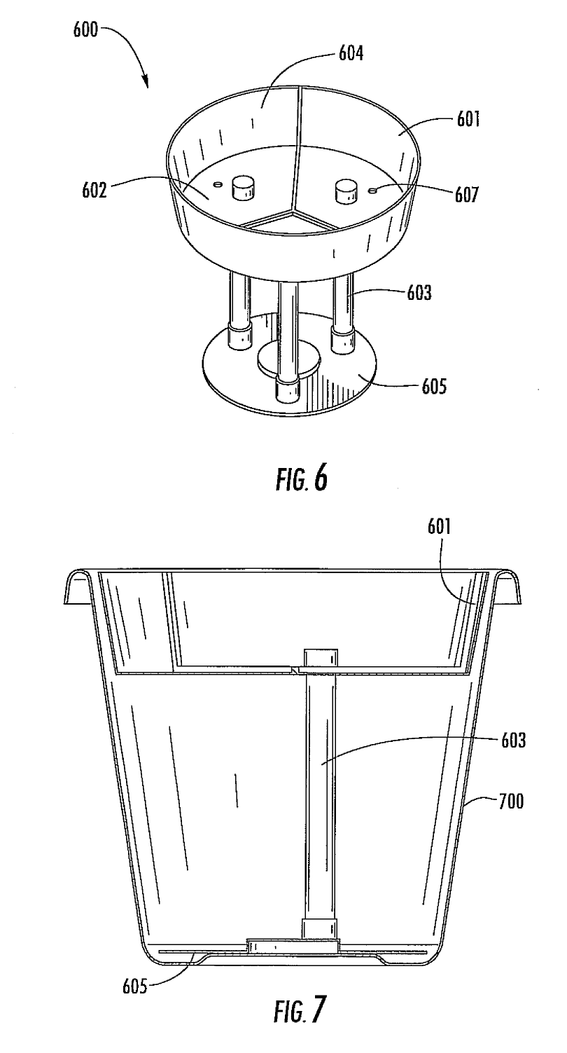

FIG. 6 is a top perspective view of a leg-supported tray 600 according to another embodiment of the present invention. In this embodiment, each of a plurality of legs 603 is affixed to a bottom end of a tray 601 at a first end. The tray 601 comprises a tray base 602 and sidewalls 604, and includes at least one aperture 607 (e.g., for drainage).

A second end of the legs 603 is preferably affixed to a top side of a bottom plate 605. As shown in this exemplary embodiment, three legs 603 may be provided in a ‘tripod’ configuration for improved weight distribution and stability, however, the use of any number of legs (e.g., one or more) may be contemplated. The legs 603 may be provided in a variety of lengths as desired. Furthermore, while a circular tray and bottom plate are shown in this embodiment, this is by way of example and not by limitation, and any other shape (e.g., polygonal, oval, etc.) of the tray 601 and base plate 605 may be contemplated. Any size, diameter, height and/or shape of the leg-supported tray 600 may be contemplated as desired, e.g., for fitting into a desired pot for supporting an object at a desired height therein.

FIG. 7 is a side cross-sectional view of the leg-supported tray of FIG. 6 inserted in a plant container 700 according to an aspect of the present invention. As can be seen, the leg-supported tray 600 is preferably adapted to be insertable within a pot 700.

Although the embodiment which incorporates the teachings of the present invention has been shown and described in detail herein, those skilled in the art can readily devise many other varied embodiments that still incorporate these teachings. Having described preferred embodiments for a planting platform system (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

1. A planting platform for placement within a plant container comprising:
a base having a perimeter;
a sidewall having a bottom portion connected to the perimeter of the base, the sidewall having a top portion and including a lip protruding radially outwards from the top portion thereof, wherein the lip includes a barrier edge extending upwards from an outer perimeter of the lip, and wherein the lip protrudes outwards from the top portion of the sidewall for a distance of at least 3 inches.

2. The planting platform of claim 1, wherein the base includes at least one aperture.

3. The planting platform of claim 1, wherein the sidewall is graduated in size from the bottom portion to the top portion.

4. The planting platform of claim 1, wherein the lip is configured to rest on top of the container so as to suspend the planting platform within the container at a top end thereof

5. The planting platform of claim 1, wherein a depth of the platform is about ¼ to ⅓ of a depth of the container.

6. (canceled)

7. The planting platform of claim 1, wherein the barrier edge extends at least ¼ inch upwards from the lip.

8. A planting system comprising:
a plant container having a depth and a top rim defining a top opening;
a planting platform configured for insertion within the top opening of the plant container, the platform comprising
a base having a perimeter;
a sidewall having a bottom portion connected to the perimeter of the base, the sidewall having a top portion and including a lip protruding radially outwards from the top portion thereof, wherein the lip includes a barrier edge extending upwards from an outer perimeter of the lip, wherein the lip protrudes outwards past an outermost edge of the top rim of the plant container when the planting platform is inserted into the plant container.

9. The planting system of claim 8, wherein the base includes at least one drainage aperture.

10. The planting system of claim 8, wherein the base is at least one of an slanted, multi-sided or curved shape.

11. The planting system of claim 8, wherein the lip is configured to rest on top of the rim of the container so as to suspend the planting platform within the container at the top opening thereof.

12. The planting system of claim 8, wherein a depth of the planting platform is about ¼ to ⅓ of a depth of the container.

13. The planting system of claim 8, wherein the lip protrudes outwards from the top portion of the sidewall for a distance of at least 3 inches.

14. The planting system of claim 8, wherein the baffler edge extends at least ¼ inch upwards from the lip.

15. A planting platform for placement within a plant container comprising:
a tray base having a perimeter;
a sidewall having a bottom portion connected along the perimeter of the base;
a bottom plate; and
at least one leg having a first end connected to the tray base and a second end connected to the bottom plate.

16. The planting platform of claim 15, wherein the tray base includes at least one aperture.

17. The planting platform of claim 15, wherein the perimeter of the tray base and the bottom plate comprises at least one of a circular, oval, or polygonal shape.

18. The planting platform of claim 1, wherein the lip protrudes outwards past an outermost edge of a top rim of the plant container when the planting platform is placed into the plant container.

19. The planting platform of claim 1, wherein at least a perimeter of the lip and a perimeter of the baffler edge comprises a polygonal shape.

20. The planting platform of claim 8, wherein at least a perimeter of the lip and a perimeter of the baffler edge comprises a polygonal shape.
